(19) United States
(12) Patent Application Publication
(10) Pub. No.: US 2004/0199400 A1
(43) Pub. Date: Oct. 7, 2004

(54) Internet-based patent and trademark application management system

(76) Inventor: Steven W. Lundberg, Edina, MN (US)

Correspondence Address: Robert D. Hunt, 23707 Redfish Lane, Pass Christian, MS, 39571, US

(21) Appl. No.: 10/741,166

(22) Filed: Dec. 17, 2003

Related U.S. Application Data
(60) Provisional application No. 60/433,944, filed on Dec. 17, 2002.
(60) Provisional application No. 60/433,935, filed on Dec. 17, 2002.

(51) Int. Cl. G06F 17/60

(52) U.S. Cl. 705/1

(57) ABSTRACT

The present invention includes a system for a law firm to interact with clients, comprising: an enterprise platform that includes file wrapper means; messaging means; docketing means; reference means; and notice means wherein a law firm notifies the client of a change in status of one or more of file wrapper means, messaging means, docketing means, and reference means.

### CROSS-REFERENCE TO RELATED APPLICATION(s)

This application claims the benefit of U.S. Provisional Application Serial No. 60/433,944, filed Dec. 17, 2002, under 35 U.S.C. 119(e).

### FIELD OF THE INVENTION

The invention relates generally to managing patent and trademark applications, and more specifically to an internet-based system for management of patent and trademark applications.

### BACKGROUND OF THE INVENTION

Patent agents and attorneys that specialize in patent prosecution typically draft dozens of patent applications per year, and are engaged in prosecution of many more. Each of these must be carefully tracked by the patent attorney or legal assistant, so that important status information such as potential bar dates, deadlines for response to office action amendments and responses, and other data are not overlooked. Management of this data has historically been managed by inclusion of each item on a docket that is tracked on paper docketing calendars, or more recently using commercially available electronic docketing software that serves the same purpose as a calendar.

But, when multiple attorneys are involved in docketed matters for multiple clients, when complex client or legal rules must be applied, or when corporate clients wish to participate in the docket management of matters on a law firm or attorney's docket, docket management using paper calendars and simple docketing software can become labor-intensive and subject to errors. It is not uncommon for paper checklists of application drafting guidelines from clients, e-mail messages relating to a case, and multiple copies of docketing information to be kept separately for each patent or trademark application managed by an attorney or firm. Coordination and communication of this information is not a trivial task, and requires a significant amount of time and attention from the typical patent attorney or agent.

The client is typically unable to participate in or monitor the management of a matter within a law firm, and must largely trust the law firm with the responsibility of appropriately managing matters that have been entrusted to the firm. Similarly, the law firm must rely on the client to provide sufficient documentation and support such as potential bar date information to enable the law firm to manage the legal matter. When a matter is assigned to a law firm, cpoies of documentation relating to the matter are typically sent to the law firm, which keeps its own records separate from those of the client. As various events relating to the matters under management occur, the client and law firm typically send letters to each other so that each is aware of the status of the matter.

A system for managing patent and trademark applications and information related to these applications is desired, as well as a system to facilitate communication and coordination of this application-related information between clients and law firms.

### DETAILED DESCRIPTION

In the following detailed description of sample embodiments of the invention, reference is made to various examples which is shown by way of illustration specific sample embodiments in which the invention may be practiced. These embodiments are described in sufficient detail to enable those skilled in the art to practice the invention, and it is to be understood that other embodiments may be utilized and that logical, mechanical, electrical, and other changes may be made without departing from the spirit or scope of the present invention. Further, various combinations of the elements described in the example embodiments of the invention discussed herein are expressly within the scope of the present invention.

In one embodiment of the invention, a web-based service provides a legal entity or a client or other affiliate of a legal entity access to data management functions to facilitate legal proceedings. A law firm utilizes the web-based system to track data for a client, such as patent and trademark status, docketing, documentation, and billing.

The client is provided access to the web-based system, and when the client accesses the system is offered account setup functions which when selected enable the client to utilize the system to perform various functions separate from and optionally visible to the law firm. For example, an invention disclosure management module may be a part of the web-based service that is utilized by the client, but invention disclosures entered into and managed by the system will not be visible to the law firm until they are released to the law firm's attention. The client may therefore use the web-based system to store invention disclosures and use them for evaluation, budgeting, awarding of inventor stipends, or for other functions that are not initially or may never be visible to the law firm, as well as to record disclosure information that is selectively or entirely released to the attention of the law firm or to any other law firm.

Invention disclosure management in further embodiments includes a function for receiving invention disclosures and for time-stamping receipt of received disclosures for date of invention record verification purposes. Also, the invention disclosure module comprises a facility so that reviewers of an invention disclosure may electronically witness and sign an invention disclosure, such that the signature of the signing witnesses is further date-stamped with data indicating the date of electronic signing.

The invention tracking module in some embodiments is further operable to track potential bar dates relating to national and international filing, based on data entered relating to an offer for sale, public use, publication, or other activities relating to the invention. The module provides notice at various dates to the client of nearing potential bar dates, alerting the client to the potential bar date and the action that must be taken to ensure rights are not lost.

The functions available to the client also include in some embodiments calendar or date tracking functions relating to various activities performed in the course of IP management, such as invention disclosure meetings, attorney meetings, technical review board meetings, etc., and if applicable further track decisions or results of these meetings such as whether to pursue a patent application relating to a specific invention disclosure.

One module of the web-based system usable for client data management comprises a data registry of various intellectual property held, such as records relating to trade secret identification and retention, a record of various trademarks and their uses and relevant registration or other legal information, and a patent portfolio log indicating issued patents and their various characteristics such as keyword and subject classification data such that a client may readily view and understand a record of his intellectual property holdings. In a further embodiment of the invention, the web-based system comprises a module operable to search the data relating to these various intellectual property assets, and to produce an intellectual property report or audit.

The client system will in some embodiments include a document system enabling creation or merging of various documents relating to intellectual property matters. License agreements, assignments, non-disclosure agreements, and other such legal documents are examples of documents that will be useful to clients and are included in the various embodiments of the invention.

The client's account data can be readily exchanged with the law firm via the web-management system in some embodiments, such that invention disclosure and potential bar date information relating to a case can be made available to the law firm once the decision to pursue a patent for a particular invention disclosure is made. In further embodiments, the web-based system provides issued patent or other reference search capability in various embodiments to the law firm and to the client for performing and documenting an electronic patentability search and review, so that results of a patentability search relating to an invention disclosure can be stored, and relevant documents recorded for preparation of an Information Disclosure Statement.

Further, the law firm and the client are capable of exchanging other data via the web-based system, such as submission of a trademark, copyright, or trade secret matter for various purposes, as well as capability to track and coordinate data relating to other matters such as opinion-related issues and work. In one embodiment of the invention, these various intellectual property matters are identified to the client and to the law firm by a matter or activity identifier which need not be the same for both client and law firm, but which identify the same matter and enable identification and specification of data relating to the various matters in which the law firm and client are involved. In addition to matter identifier-based viewing of data, the web-based module in various embodiments comprises activity-based views in which an entity may view the various activities requiring attention for his various matters, may view all matters which have a certain activity pending, or may view another activity-based view of the intellectual property matters under management.

In some embodiments of the invention, the web-based systems used by the client and the law firm are the same computerized system, while in other embodiments they are separate computerized systems but are operable to exchange data as appropriate for proper operation of the invention as described in the above various examples. In some embodiments where the same system is used, various forms of encryption are used to ensure the confidentiality of data as it travels over the Internet or other network. In embodiments where a separate computerized system is utilized by the client, the client may install and configure his own computerized system to host a local web-based system consistent with the present invention such that the client's confidential information such as trade secret information and invention disclosures not released to external entities are held within systems under the client's control. Such systems will be able to exchange data with other computerized data management systems under the client's direction, and so provide the various functions discussed in the example embodiments of the invention presented herein.

1. A system for a law firm to interact with clients, comprising:
an enterprise platform that includes file wrapper means;
messaging means;
docketing means;
reference means; and
notice means wherein a law firm notifies the client of a change in status of one or more of file wrapper means, messaging means, docketing means, and reference means.

2. The system of claim 1 wherein the notice is automatically generated upon a change in data.
